(19) United States
(12) Patent Application Publication
(10) Pub. No.: US 2021/0064673 A1
(43) Pub. Date: Mar. 4, 2021

(54) INFORMATION PROCESSING APPARATUS AND INFORMATION PROCESSING SYSTEM

(71) Applicant: FUJI XEROX CO., LTD., Tokyo (JP)

(72) Inventor: Ryosuke MURAKAMI, Kanagawa (JP)

(73) Assignee: FUJI XEROX CO., LTD., Tokyo (JP)

(21) Appl. No.: 16/819,256

(22) Filed: Mar. 16, 2020

(30) Foreign Application Priority Data
Sep. 4, 2019 (JP) 2019-161601

(51) Int. Cl. G06F 16/93; G06F 3/0484; G06F 16/23

(52) U.S. Cl. CPC G06F 16/93; G06F 16/2379; G06F 3/04847

(57) ABSTRACT

An information processing apparatus includes a reception unit that receives update of a setting value set for an electronic document, an extraction unit that extracts a related setting value, which relates to the setting value to be updated and is to be updated together with the setting value, in accordance with the setting value, a presentation unit that presents the related setting value to a user, and an update unit that, if the user gives an instruction to update the related setting value, simultaneously updates the setting value and the related setting value.

### CROSS-REFERENCE TO RELATED APPLICATIONS

This application is based on and claims priority under 35 USC 119 from Japanese Patent Application No. 2019-161601 filed Sep. 4, 2019.

### BACKGROUND

### (i) Technical Field

The present disclosure relates to an information processing apparatus and an information processing system.

### (ii) Related Art

Information processing apparatuses that simultaneously change plural setting values input by a user have been conventionally used.

Japanese Unexamined Patent Application Publication No. 2017-98805 discloses an information processing apparatus. If, when a user has given an instruction to change a setting value from a menu, the information processing apparatus determines that a selected setting item is a certain item to be simultaneously changed, the information processing apparatus successively receives plural setting values to be simultaneously changed. If the user selects a button for reflecting the received plural setting values displayed on a display unit, the information processing apparatus simultaneously updates plural setting values stored therein with the received plural setting values.

### SUMMARY

Items of setting values to be changed are preset in the information processing apparatus, and a setting value is not assumed to be changed in accordance with each user.

There are some cases, however, where it is not desirable to preset items of setting values to be changed in the information processing apparatus, such as when a user desires to simultaneously change a setting value for plural electronic documents and when a user desires to change a setting value in accordance with a use state of the user. In this case, the setting value needs to be changed for each electronic document, which makes management of the electronic documents cumbersome. This problem arises not only when a setting value is changed but also when a setting value is added.

Aspects of non-limiting embodiments of the present disclosure relate to provide an information processing apparatus and the like capable of, for example, simultaneously changing or adding a related setting value together with a setting value given to an electronic document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a reception unit that receives update of a setting value set for an electronic document, an extraction unit that extracts a related setting value, which relates to the setting value to be updated and is to be updated together with the setting value, in accordance with the setting value, a presentation unit that presents the related setting value to a user, and an update unit that, if the user gives an instruction to update the related setting value, simultaneously updates the setting value and the related setting value.

### BRIEF DESCRIPTION OF THE DRAWINGS

An exemplary embodiment of the present disclosure will be described in detail based on the following figure, wherein:

FIG. 1 is a diagram illustrating an example of the configuration of an information processing system according to exemplary embodiments;

FIG. 2 is a diagram illustrating an example of an outline of the operation of the information processing system;

FIG. 3 is a block diagram illustrating an example of the functional configuration of a document management server;

FIG. 4A is a diagram illustrating electronic documents to be used in the description of the exemplary embodiment and FIG. 4B is a diagram illustrating parameters set for the electronic documents illustrated in FIG. 4A;

FIG. 5 is a diagram illustrating a specific example of the parameters set for the electronic documents;

FIG. 6 is a diagram illustrating a screen on which a user changes a setting value;

FIG. 7 is a diagram illustrating a screen displayed after the user changes a parameter on the screen illustrated in FIG. 6;

FIG. 8 illustrates a screen displayed after the user presses an OK button illustrated in FIG. 7;

FIG. 9 is a flowchart illustrating an example of an operation of the information processing system according to a first exemplary embodiment;

FIG. 10 illustrates a screen on which attributes for managing electronic documents are displayed;

FIG. 11 is a diagram illustrating display settings and search settings;

FIG. 12 is a diagram illustrating a list screen;

FIG. 13 is a diagram illustrating a detailed screen;

FIG. 14 is a diagram illustrating a case where management attributes have been added;

FIG. 15 is a diagram illustrating display settings and search settings presented to the user; and

FIG. 16 is a flowchart illustrating an example of an operation of the information processing system according to a second exemplary embodiment.

### DETAILED DESCRIPTION

Outline of Information Processing System

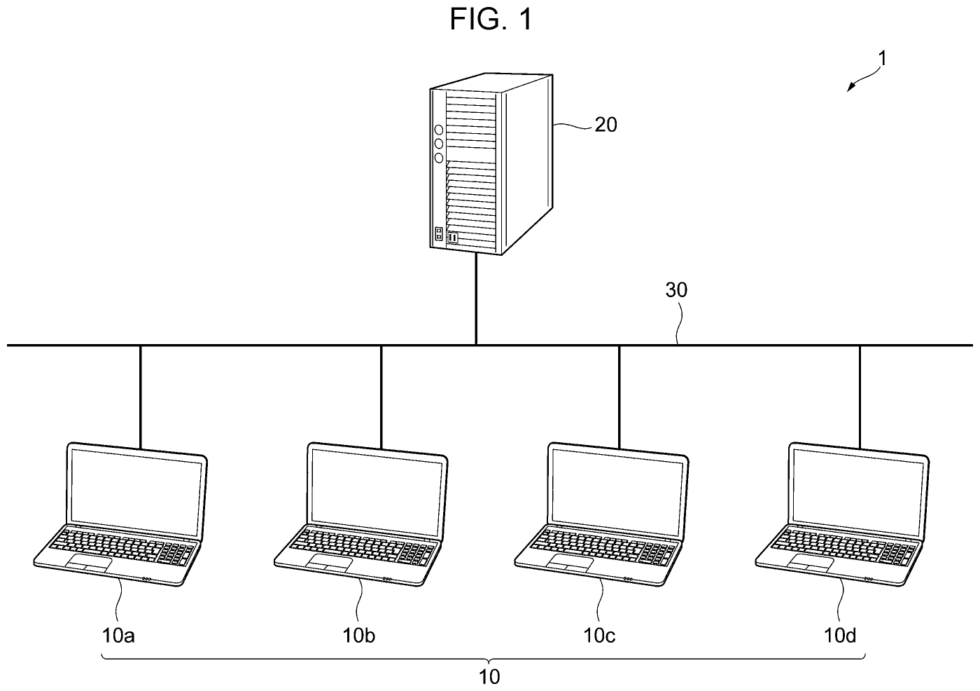

FIG. 1 is a diagram illustrating an example of the configuration of an information processing system 1 according to exemplary embodiments.

In the information processing system 1 illustrated in FIG. 1, terminal apparatuses 10a to 10d, which are generically referred to as “terminal apparatuses 10”, and a document management server 20 are connected to each other over a network 30.

FIG. 1 illustrates an example in which each of the terminal apparatuses 10a to 10d is used in one of phases of a project consisting of planning, development, evaluation, and release.

Any number of terminal apparatuses 10, however, may be used. In addition, the terminal apparatuses 10 need not be used in correspondence with phases. For example, the terminal apparatuses 10 may be used in correspondence with groups of an organization, instead. The groups are, for example, departments of a company. Furthermore, plural terminal apparatuses 10 may be provided for each phase or the like.

The information processing system 1 illustrated in FIG. 1 manages, for example, electronic documents used for a product development project.

The electronic documents are any kind of electronic information. Information types, formats, and data structures of electronic documents are not particularly limited insofar as the electronic documents can be handled by the terminal apparatuses 10 and the document management server 20. The electronic documents include, for example, electronic documents such as text information and image information, software such as programs, and information regarding the software such as setting information.

Each if the terminal apparatuses 10 is an example of viewing means for viewing electronic documents. The terminal apparatuses 10 can also create and edit electronic documents. The terminal apparatuses 10 are, for example, computer apparatuses such as general-purpose personal computers (PCs), mobile computers, mobile phones, smartphones, or tablet computers. The terminal apparatuses 10 operate various pieces of application software under management by an operating system (OS) to create, edit, and view the electronic documents managed by the document management server 20.

The document management server 20 is an example of an information processing apparatus that manages electronic documents and is a server computer that manages the entirety of the information processing system 1. For example, the document management server 20 authenticates users who operate the terminal apparatuses 10 and transmit electronic documents to the terminal apparatuses 10 in order to view the electronic documents. The document management server 20 also receives electronic documents from the terminal apparatuses 10 and saves the received electronic documents.

The terminal apparatuses 10 and the document management server 20 each include a central processing unit (CPU), which is processing means, a memory, which is storage means, and a storage such as a hard disk drive (HDD) or a solid-state drive (SSD). Here, the CPU executes various pieces of software such as the OS (basic software) and application software (applied software). The memory is a storage area in which the various pieces of software, data used to execute the various pieces of software, and the like are stored. The storage is a storage area in which data input to the various pieces of software, data output from the various pieces of software, and the like are stored.

Furthermore, the terminal apparatuses 10 and the document management server 20 each include a communication interface for communicating with the outside, a display mechanism including a video memory and a display, and an input device such as a keyboard, a mouse, or a touch panel.

The network 30 is communication means used for information communication between the terminal apparatuses 10 and the document management server 20 and is, for example, the Internet, a local area network (LAN), or an access point.

Outline of Operation of Information Processing System 1

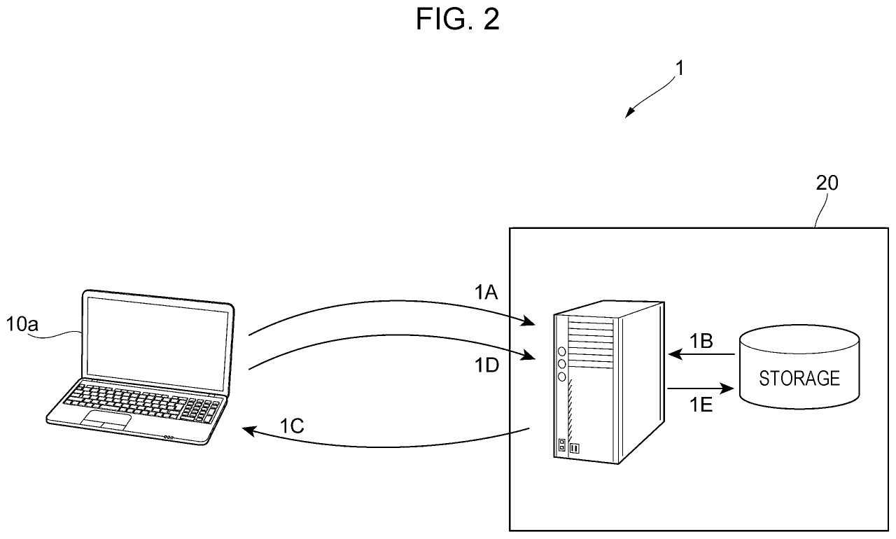

FIG. 2 is a diagram illustrating an example of an outline of the operation of the information processing system 1.

In this example, a user U who is in charge of the planning phase updates a setting value of an electronic document using the terminal apparatus 10a.

A setting value is a value set to handle an electronic document. A description mode of values is not particularly limited, and numbers, letters, signs, and the like may be used. In the exemplary embodiments, identifier names, storage repositories, access rights, attributes, and the like will be described later as setting values of electronic documents.

First, the user U operates software, such as a browser, operating on the terminal apparatus 10a and authenticates himself/herself for the document management server 20. The user U then gives, to the document management server 20, an instruction to update a setting value of an electronic document (1A).

Upon receiving the instruction to update the setting value, the document management server 20 extracts electronic documents relating to the foregoing electronic document from the storage (1B). The electronic documents to be extracted are electronic documents for which the same setting value as on a plan sheet needs to be updated together with the setting value on the plan sheet. A method for extracting related electronic documents will be described later.

The document management server 20 then transmits a list of the extracted electronic documents to the terminal apparatus 10a, and the terminal apparatus 10a displays the list (1C).

The user U views the list and gives, to the document management server 20, an instruction to simultaneously update the setting values of the electronic documents (1D).

Upon receiving the instruction, the document management server 20 simultaneously updates the setting values of the electronic documents to be updated saved in the storage (1E).

### Functional Configuration of Document Management Server 20

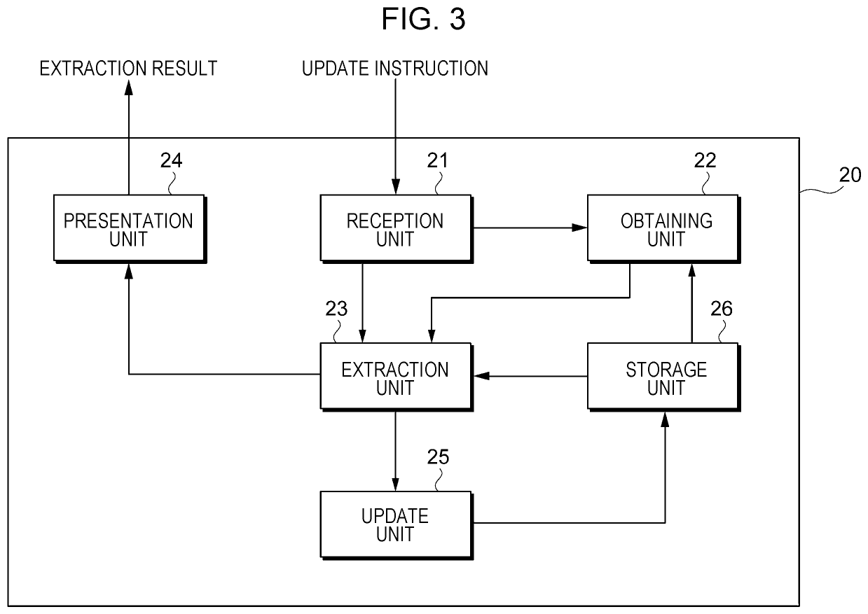

FIG. 3 is a block diagram illustrating an example of the functional configuration of the document management server 20.

Here, only functions of the information processing system 1 relating to the exemplary embodiments are selected and illustrated.

The document management server 20 illustrated in FIG. 3 includes a reception unit 21 that receives an instruction to update a setting value of an electronic document, an obtaining unit 22 that obtains a setting value of an electronic document, an extraction unit 23 that extracts related electronic documents, a presentation unit 24 that presents related electronic documents to the users of the terminal apparatuses 10, an update unit 25 that updates setting values, and a storage unit 26 that stores electronic documents.

The reception unit 21 receives an instruction to update a setting value of an electronic document from one of the terminal apparatuses 10. The instruction is given by the user who operates the terminal apparatus 10. The reception unit 21 is an example of reception means for receiving update of a setting value set for an electronic document. The reception unit 21 also receives an instruction to collectively update setting values of plural electronic documents extracted by the extraction unit 23.

The obtaining unit 22 obtains a setting value from the instruction to update a setting value received by the reception unit 21.

The extraction unit 23 is an example of extraction means and extracts a related setting value. A related setting value is a setting value relating to a setting value to be updated and to be updated together with the setting value to be updated. The related setting value is extracted in accordance with the setting value. When the setting value is different, the related setting value may also be different. Each time an instruction to update a setting value of an electronic document is given, the extraction unit 23 sets a related setting value relating to the setting value.

The presentation unit 24 is an example of presentation means and presents a related setting value to the user. For example, the presentation unit 24 creates a table on which a related setting value and electronic documents corresponding to the related setting value are associated with each other as a result of extraction and presents the table to the user U who has given an instruction to change a setting value. A table to be presented will be described later.

The update unit 25 is an example of update means and, when the user has given an instruction to update a setting value, simultaneously updates the setting value and a related setting value. As a result, the setting value is updated, and the related setting value, which relates to the setting value and is to be updated together with the setting value, is also updated.

The storage unit 26 stores electronic documents and setting values of the electronic documents. The obtaining unit 22 refers to the storage unit 26 and obtains setting values and related setting values.

For example, the reception unit 21 and the presentation unit 24 can be achieved by a communication interface. For example, the obtaining unit 22, the extraction unit 23, and the update unit 25 can be achieved by a CPU. Furthermore, the storage unit 26 can be achieved by a storage.

### Operation of Document Management Server 20

### First Exemplary Embodiment

First, an operation of the document management server 20 according to a first exemplary embodiment will be described.

In the first exemplary embodiment, a case will be described where the document management server 20 changes a setting value of an electronic document as update of a setting value.

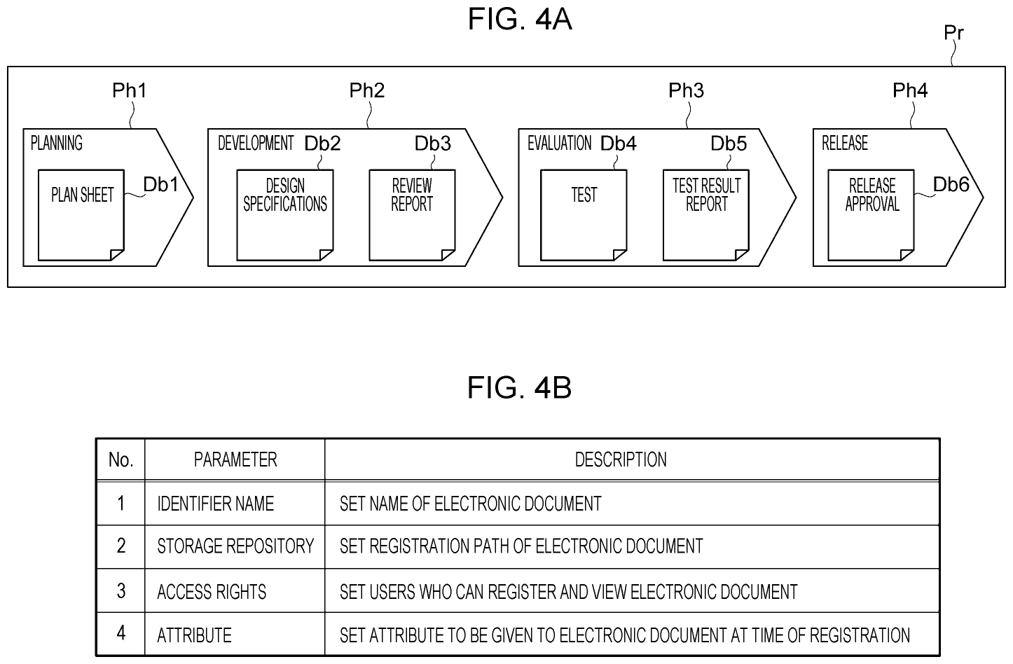

FIG. 4A is a diagram illustrating electronic documents to be used in the description of the exemplary embodiments.

FIG. 4A illustrates six electronic documents Db1 to Db6. The electronic documents Db1 to Db6 are used in a planning phase Ph1, a development phase Ph2, an evaluation phase Ph3, and a release phase Ph4 of a project Pr.

More specifically, the electronic document Db1 is used in the planning phase Ph1 and has an identifier name of “plan sheet”. The electronic documents Db2 and Db3 are used in the development phase Ph2 and have identifier names of “design specifications” and “review report”, respectively. The electronic documents Db4 and Db5 are used in the evaluation phase Ph3 and have identifier names of “test” and “test result report”, respectively. The electronic document Db6 is used in the release phase Ph4 and has an identifier name of “release approval”. These electronic documents are necessary to perform an operation for completing the project Pr through the phases Ph1 to Ph4. That is, the electronic documents Db1 to Db6 are related to one another in this operation.

FIG. 4B is a diagram illustrating parameters set for the electronic documents Db1 to Db6 illustrated in FIG. 4A.

The parameters are an example of setting values. Here, “identifier name”, “storage repository”, “access rights”, and “attribute”, which are indicated by No. 1 to No. 4, respectively, are set for the electronic documents Db1 to Db6 as the parameters. As illustrated in FIG. 4B, “identifier name” is a parameter for setting a name of an electronic document. “Storage repository” is a parameter for setting a registration path of an electronic document. “Access rights” is a parameter for setting users who can register and view an electronic document. “attribute” is a parameter for setting an attribute to be given to an electronic document when the electronic document is registered.

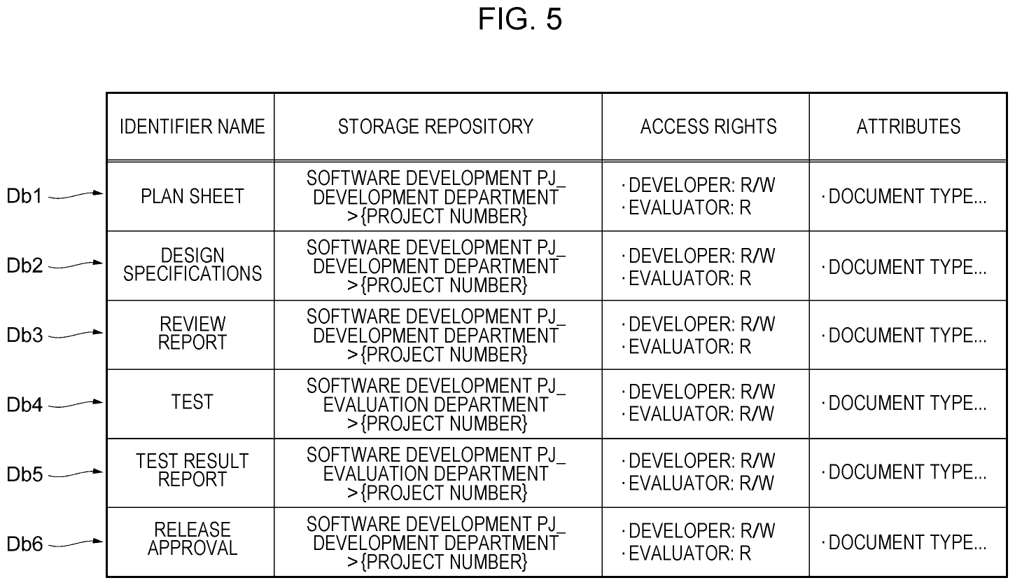

FIG. 5 is a diagram illustrating a specific example of the parameters set for the electronic documents Db1 to Db6.

The electronic document Db1 will be taken as an example. “Identifier name” of the electronic document Db1 is “plan sheet”. “Storage repository” is “software development PJ_development department>{project number}”. As for “access rights”, a developer is “R/W” (may read and write), and an evaluator is “R” (may read). “Attribute” is “document type”.

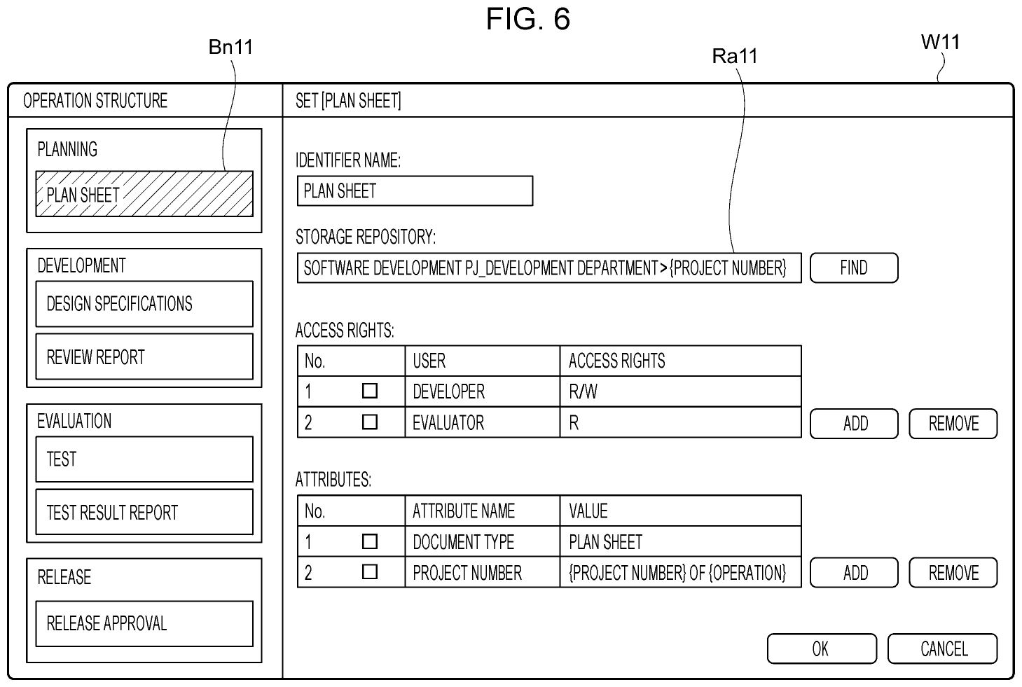

FIG. 6 is a diagram illustrating a screen on which the user changes a setting value.

A window W11 is displayed on the screen. Buttons indicating the identifier names of the electronic documents Db1 to Db6 are provided in a left part of the window W11 illustrated in FIG. 6. If the user presses a button Bn11 indicating “plan sheet”, which is the identifier name of the electronic document Db1, for example, a list of setting values of the electronic document Db1 is displayed in a right part of the window W11. The user can then change parameters using the list of setting values.

For example, the user changes “storage repository”. The user changes text displayed in an input field Ra11 for this purpose. In FIG. 6, “storage repository” is currently “software development PJ_development department>{project number}”.

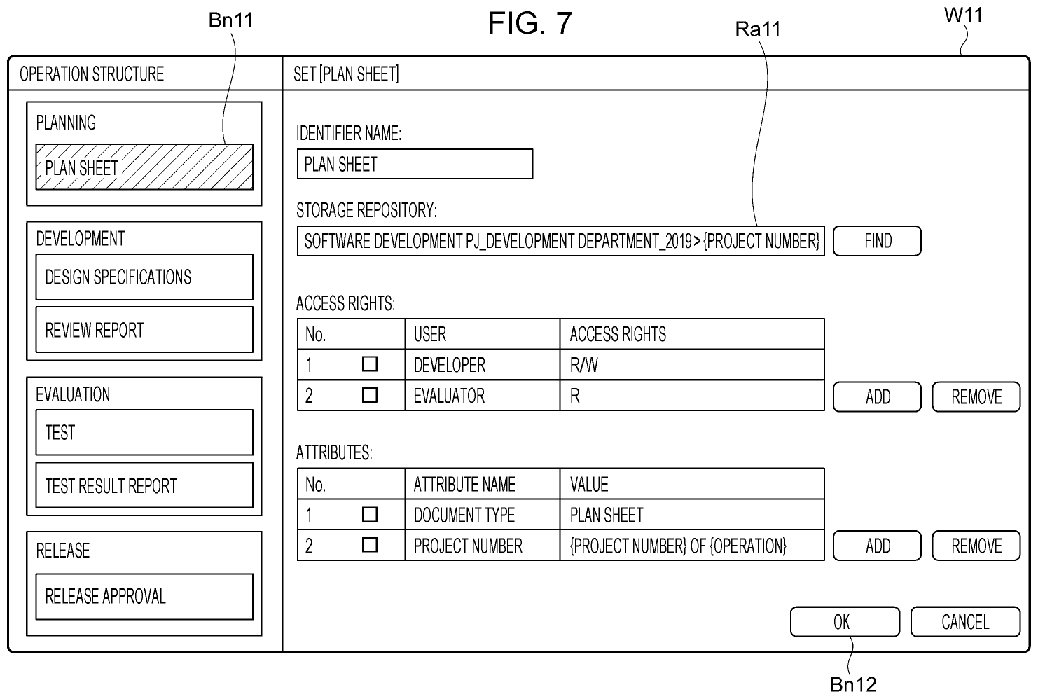

FIG. 7 is a diagram illustrating a screen displayed after the user changes a parameter on the screen illustrated in FIG. 6.

Here, the user has changed “storage repository” to “software development PJ_development department_2019>{project number}” in the input field Ra11 of the window W11. That is, the user has added “_2019” to the original parameter.

The user then presses an OK button Bn12 to confirm the change to the parameter.

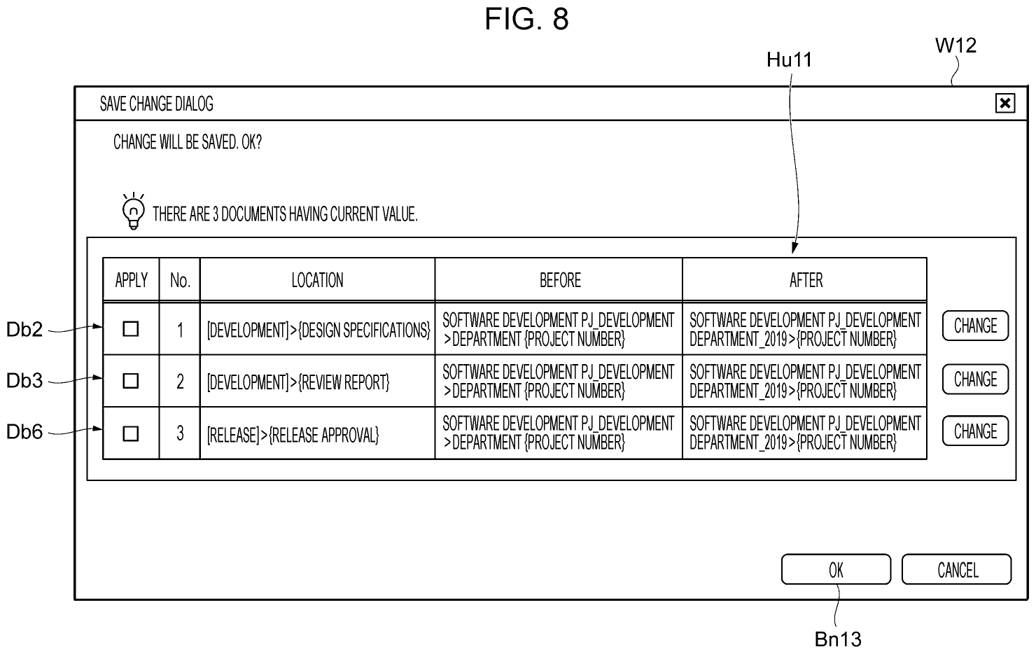

FIG. 8 illustrates a screen displayed after the user presses the OK button Bn12 illustrated in FIG. 7.

Here, a table Hull is displayed in a window W12. Here, a setting value to be changed is a storage repository. The obtaining unit 22 obtains the original storage repository as the setting value. The extraction unit 23 then determines the same setting values as the original setting value as related setting values, which are to be updated together with the setting value. That is, the extraction unit 23 determines both the setting value and the related setting values as storage repositories in which the electronic document Db1 is saved. That is, the setting value and the related setting values are both “software development PJ_development department>{project number}”.

Furthermore, the extraction unit 23 extracts electronic documents having the related setting values. That is, the extraction unit 23 extracts electronic documents whose storage repositories are “software development PJ_development department>{project number}”. In FIG. 5, electronic documents having the related setting values are the electronic documents Db2, Db3, and Db6. The extraction unit 23, therefore, extracts the electronic documents Db2, Db3, and Db6.

The presentation unit 24 then presents the related setting values to the user. In this case, the original storage repository is presented on the table Hull as the related setting values, and the new storage repository is also presented. The presentation unit 24 also presents the electronic documents Db2, Db3, and Db6, to which the related setting values are given, on the table Hull. Here, the presentation unit 24 presents phases and identifier names on the table Hull as locations of the electronic documents Db2, Db3, and Db6.

If the user presses an OK button Bn13, the update unit 25 simultaneously changes the electronic document Db1, which has the setting value, and the electronic documents Db2, Db3, and Db6, which have the related setting values. In this case, the storage repositories of the electronic documents Db1, Db2, Db3, and Db6 are changed from “software development PJ_development department>{project number}” to “software development PJ_development department_2019>{project number}”

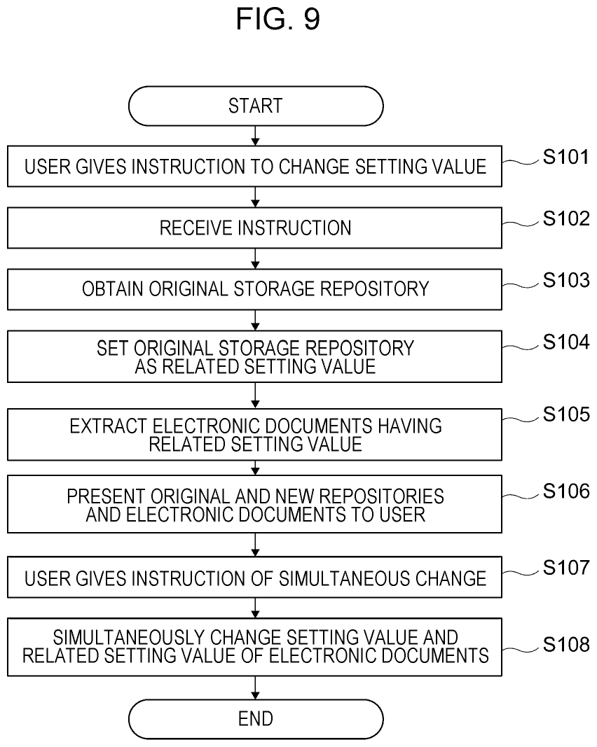

FIG. 9 is a flowchart illustrating an example of the operation of the information processing system 1 according to the first exemplary embodiment.

First, the user operates the terminal apparatuses 10 to give an instruction to change “storage repository”, which is a setting value of the electronic document Db1 (S101). As described with reference to FIGS. 6 and 7, the user inputs a new setting value on the list of setting values displayed in the window W11. In this case, the user inputs a storage repository to the input field Ra11 as a new setting value. Here, the new setting value is “software development PJ_development department_2019>{project number}”.

The reception unit 21 of the document management server 20 receives the instruction (S102).

The obtaining unit 22 then obtains the setting value to be changed from the instruction received by the reception unit 21. In this case, the obtaining unit 22 obtains the original storage repository as a setting value to be changed (S103). More specifically, the setting value obtained here is “software development PJ_development department>{project number}”.

Next, the extraction unit 23 extracts a related setting value, which is to be updated together with the setting value. In this case, the extraction unit 23 determines the original setting value as the related setting value. That is, the extraction unit 23 determines the original storage repository as the related setting value (S104). More specifically, the related setting value is “software development PJ_development department>{project number}”.

The extraction unit 23 then extracts electronic documents having the related setting value (S105). In this case, the extraction unit 23 extracts the electronic documents Db2, Db3, and Db6.

The presentation unit 24 presents the original and new storage repositories and the electronic documents to the user (S106). As a result, the table Hull illustrated in FIG. 8 is displayed on the display mechanism of the terminal apparatus 10.

The user then presses the OK button Bn13 to give an instruction of simultaneous change (S107). As a result, the update unit 25 of the document management server 20 simultaneously changes the setting value or the related setting value of the electronic documents Db1, Db2, Db3, and Db6 (S108).

### Second Exemplary Embodiment

Next, an operation of the document management server 20 according to a second exemplary embodiment will be described.

In the second exemplary embodiment, a case will be described where the document management server 20 adds an attribute for managing electronic documents as update of a setting value of an electronic document.

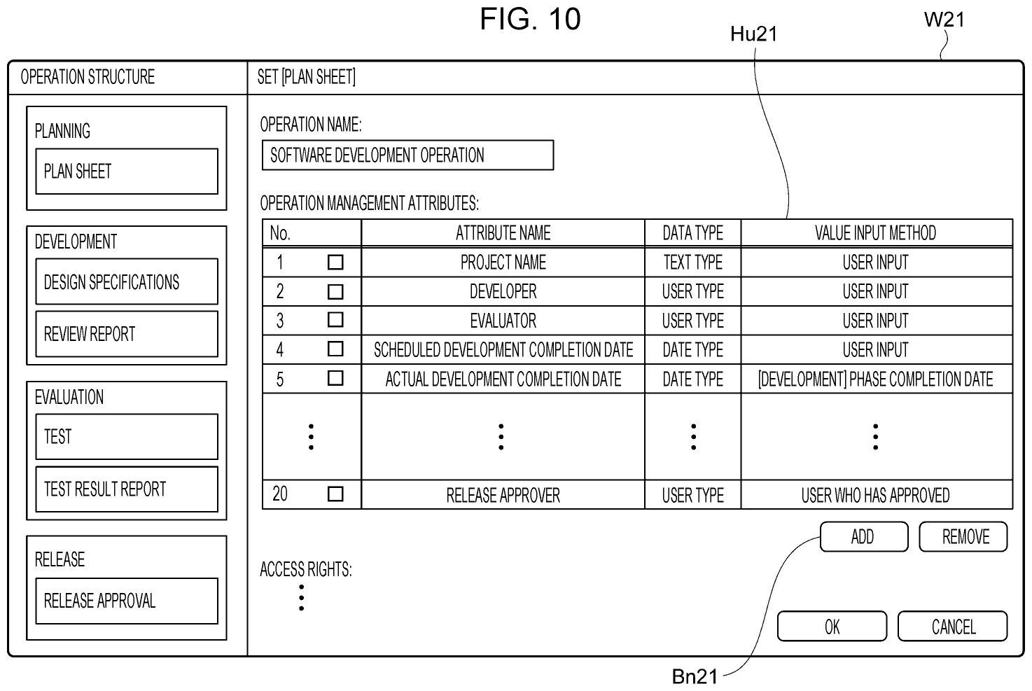

FIG. 10 illustrates a screen on which attributes for managing electronic documents are displayed.

Here, a window W21 is displayed, and the attributes for managing electronic documents are displayed on a table Hu21 in the window W21 as a list. The attributes for managing electronic documents will be referred to as “management attributes” hereinafter. Management attributes are given to electronic documents related to one another in an operation and used to manage the operation.

The table Hu21 indicates that there are 20 management attributes identified by No. 1 to No. 20, respectively.

Attribute names, data types, and value input methods of the management attributes are also displayed. As for the management attribute No. 1, for example, the attribute name is “project name”, the data type is “text type”, in which data is described in text, and the value input method is “user input”.

If the user presses an add button Bn21 on the screen, a management attribute is added.

In the present exemplary embodiment, when a management attribute, which is a setting value, has been added using the screen illustrated in FIG. 10, the extraction unit 23 extracts a setting for using the added management attribute as a related setting value. More specifically, the setting to be extracted by the extraction unit 23 is a display setting indicating whether to display management attributes. Alternatively, the setting to be extracted by the extraction unit 23 is specifically a search setting for searching for management attributes.

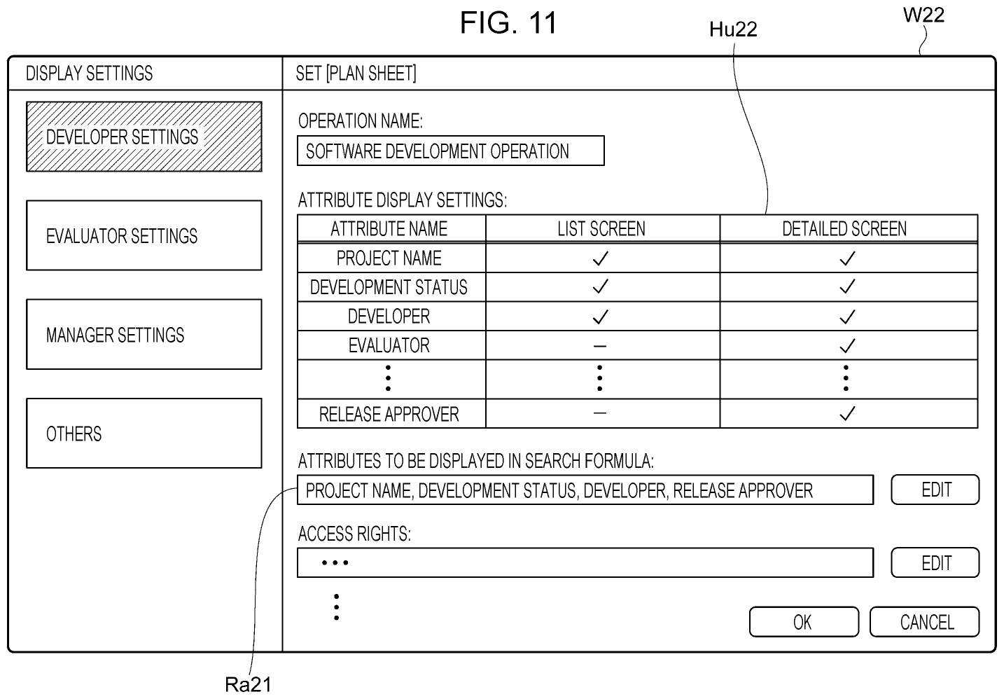

FIG. 11 is a diagram illustrating display settings and search settings.

Here, a window W22 is displayed, and a table Hu22 indicating the display settings is displayed in the window W22. In this case, the display settings are settings for determining whether to display corresponding management attributes on screens for displaying the progress of projects. The screens for displaying the progress of projects include a list screen and a detailed screen. The table Hu22 indicates which management attributes are to be displayed on each screen. A check on the table Hu22 indicates that a corresponding management attribute is to be displayed, and “-” indicates that a corresponding management attribute is not to be displayed. For example, an evaluator is not displayed on the list screen but displayed on the detailed screen.

A field Ra21 is also displayed in the window W22. The search settings are displayed in the field Ra21. In this case, the search settings are settings for determining search conditions for searching for the progress of projects. A search formula is displayed in the field Ra21 as the search settings. This search formula indicates that a project name, a development status, a developer, and a release approver can be searched for.

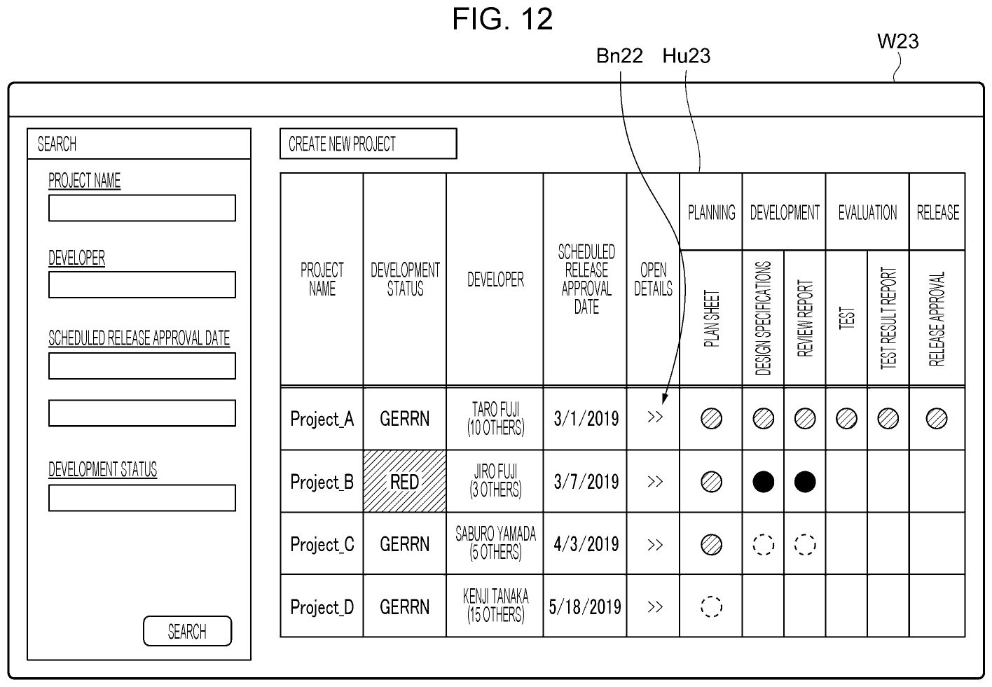

FIG. 12 is a diagram illustrating the list screen.

Here, a window W23 is displayed, and a table Hu23 indicating the list screen is displayed in the window W23. Management attributes to which a check is given in the display settings illustrated in FIG. 11 are displayed.

Here, there are four projects whose project names are “Project_A” to “Project_D”, respectively, and the progress of these projects is displayed on a list. A development status, a developer, and the like are displayed for each project as well as the project name.

If the user presses a button Bn22, which is indicated by “>>” on the table Hu23, the detailed screen, which will be described hereinafter, is displayed.

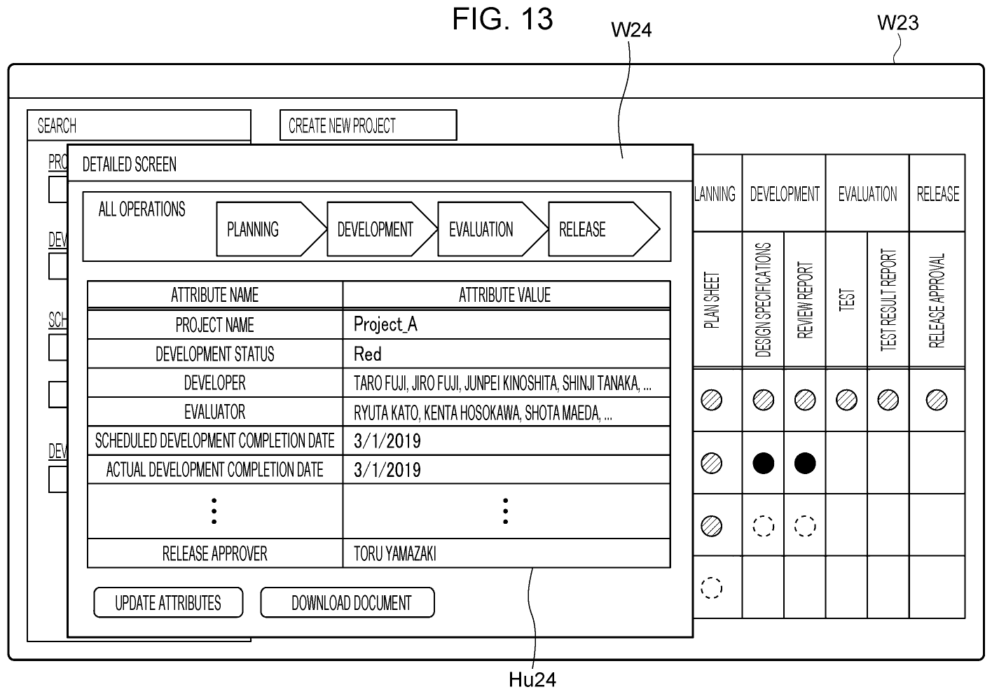

FIG. 13 is a diagram illustrating the detailed screen. Here, a window W24 is superimposed upon the window W23, and a table Hu24 is displayed in the window W24. Management attributes to which a check is given in the display settings illustrated in FIG. 11 are displayed.

The detailed screen indicates details of the progress of the project whose name is “Project_A”. A development status, a developer, an evaluator, and the like are also displayed as well as the project name.

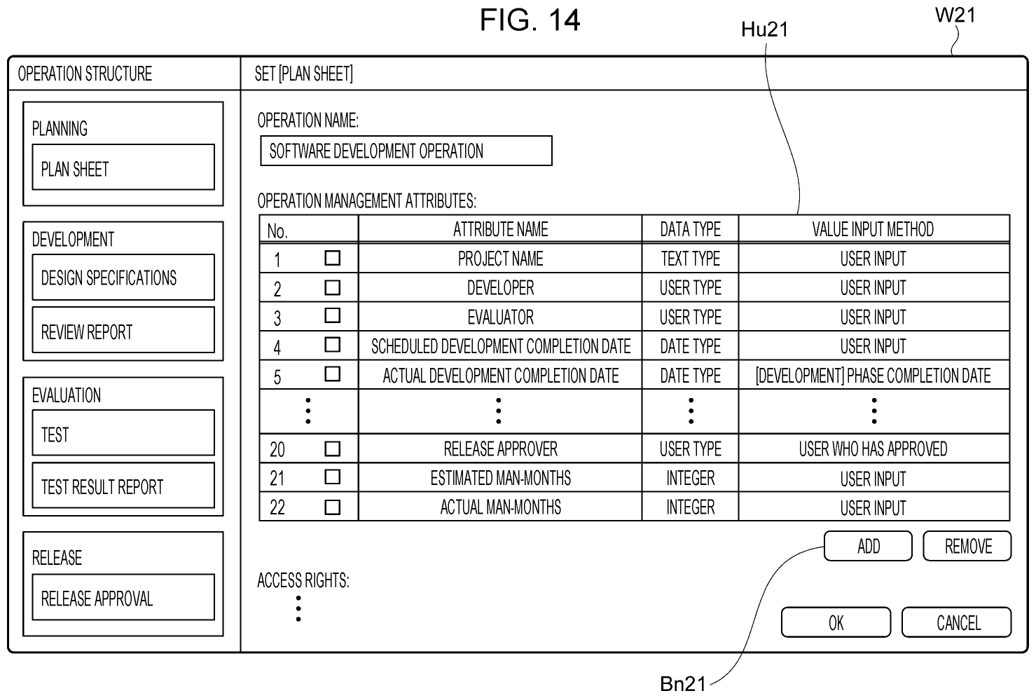

FIG. 14 is a diagram illustrating a case where management attributes have been added.

FIG. 14 illustrates a state in which the user has pressed the add button Bn21 on the screen illustrated in FIG. 10 to add management attributes. In this case, a management attribute No. 21, whose attribute name is “estimated man-months”, and a management attribute No. 22, whose attribute name is “actual man-months”, have been added compared to FIG. 10.

The extraction unit 23 then determines whether to display the added management attributes on the list screen and the detailed screen. If determining that the added management attributes are to be displayed, the extraction unit 23 changes the display settings described with reference to FIG. 11. In this case, the extraction unit 23 determines whether to display the two management attributes whose attribute names are “estimated man-months” and “actual man-months”, respectively, on the list screen and the detailed screen. If so, the extraction unit 23 adds the two management attributes to the display settings.

In order to determine whether to display the added management attributes on the list screen and the detailed screen, for example, the extraction unit 23 refers to display settings of electronic documents of other users and in other phases. If the majority of the display settings are ones for displaying the added management attributes, the extraction unit 23 makes display settings for displaying the added management attributes. If the majority of the display settings are ones for not displaying the added management attributes, the extraction unit 23 makes display settings for not displaying the added management attributes. More specifically, the extraction unit 23 sets a threshold of, say, 50%. If the percentage of settings for displaying the added management attributes is 50% or higher, the extraction unit 23 makes display settings for displaying the added management attributes. If the percentage of settings for displaying the added management attributes is lower than 50%, the extraction unit 23 makes display settings for not displaying the added management attributes.

The extraction unit 23 also determines whether to add the added management attributes to the search formula. If so, the extraction unit 23 changes the search formula displayed in field Ra21 illustrated in FIG. 11. In this case, the extraction unit 23 determines whether to add the two management attributes whose attribute names are “estimated man-months” and “actual man-months”, respectively, to the search formula.

In order to determine whether to add the added management attributes to the search formula, for example, the extraction unit 23 refers to search settings of other users and in other phases. If the majority of the search settings are ones for searching for the added management attributes, the extraction unit 23 adds the added management attributes to the search formula. If the majority of the search settings are ones for not searching for the added management attributes, the extraction unit 23 does not add the added management attributes to the search formula. More specifically, the extraction unit 23 sets a threshold of, say, 50%. If the percentage of settings for searching for the added management attributes is 50% or higher, the extraction unit 23 makes search settings for searching for the added management attributes. If the percentage of settings for searching for the added management attributes is lower than 50%, the extraction unit 23 makes search settings for not searching for the added management attributes.

The presentation unit 24 then presents the extracted related setting values to the user. In this case, the presentation unit 24 presents the display settings and the search settings to the user.

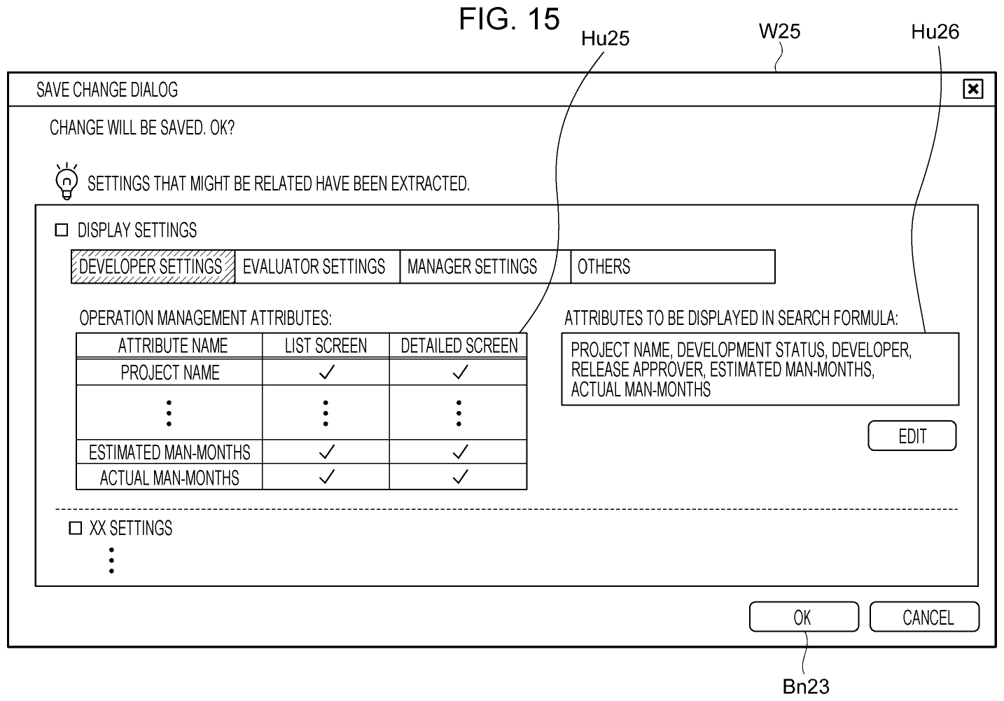

FIG. 15 is a diagram illustrating the display settings and the search settings presented to the user.

Here, a window W25 is displayed, and tables Hu25 and Hu26 are displayed in the window W25.

The table Hu25 indicates the display settings. The two management attributes whose attribute names are “estimated man-months” and “actual man-months” have been added to the display settings compared to FIG. 11. In this case, the display settings are displayed on both the list screen and the detailed screen.

The table Hu26 presents the search settings. The two management attributes whose attribute names are “estimated man-months” and “actual man-months” have been added to the search settings compared to FIG. 11.

If the user presses an OK button Bn23, the update unit 25 changes the display settings and the search settings to those illustrated in FIG. 15. The list screen illustrated in FIG. 12 and the detailed screen illustrated in FIG. 13 now also indicate the two management attributes “estimated man-months” and “actual man-months”. In addition, “estimated man-months” and “actual man-months” can also be searched for using the search formula for searching for the progress of projects.

The display settings and the search settings can be made in accordance with each user. That is, the display settings and the search settings can be set in accordance with, for example, a phase or a department to which each user belongs. The settings may also be changed in accordance with each user's authority. That is, the number of items of the display settings and the search settings is increased for a user who has a higher level of access authority. The number of items of the display settings and the search settings is decreased for a user who has a lower level of access authority. The presentation unit 24 then presents related setting values in accordance with the user's authority.

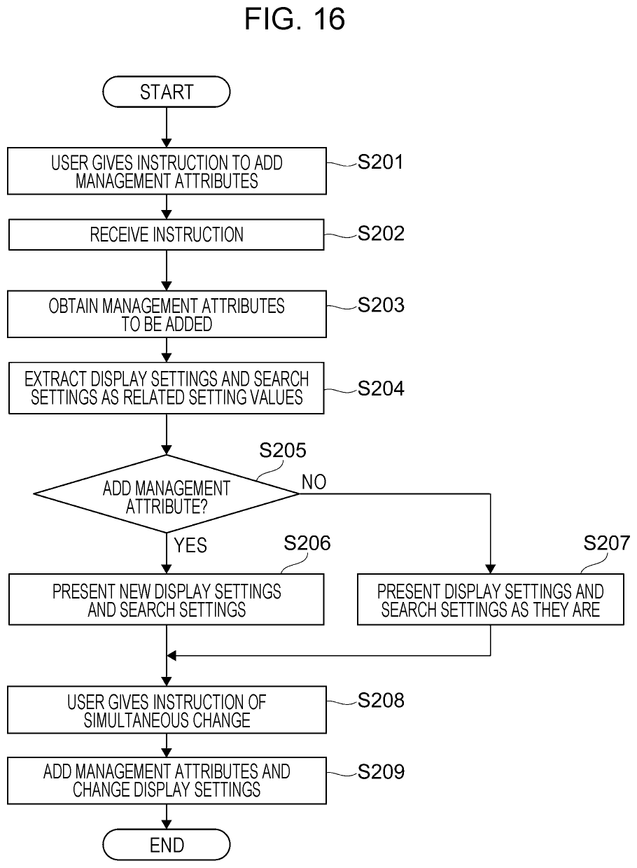

FIG. 16 is a flowchart illustrating an example of the operation of the information processing system 1 according to the second exemplary embodiment.

First, the user operates a terminal apparatus 10 to give an instruction to add management attributes (S201). The user can perform this step on the screen illustrated in FIG. 14. In this case, the user adds the two management attributes whose attribute names are “estimated man-months” and “actual man-months”.

The reception unit 21 of the document management server 20 receives the instruction (S202).

The obtaining unit 22 then obtains, from the instruction received by the reception unit 21 as setting values, the management attributes to be added (S203). In this case, the obtaining unit 22 obtains the two management attributes whose attribute names are “estimated man-months” and “actual man-months” as setting values.

Next, the extraction unit 23 extracts related setting values to be updated together with the management attributes. In this case, the extraction unit 23 extracts the display settings and the search settings as related setting values (S204). The extracted display settings and search settings are those described with reference to FIG. 11.

The extraction unit 23 then determines whether to add the added management attributes to the display settings and the search settings (S205).

If the extraction unit 23 determines that the added management attributes are to be added to the display settings and the search settings (YES in S205), the presentation unit 24 presents new display settings and search settings to the user (S206). In this case, the window W22 illustrated in FIG. 11 is displayed on the display mechanism of the terminal apparatus 10.

If the extraction unit 23 determines that the added management attributes are not to be added to the display settings and the search settings (NO in S205), the presentation unit 24 presents the display settings and the search settings as they are (S207). In this case, the window W25 illustrated in FIG. 15 is displayed on the display mechanism of the terminal apparatus 10.

If the user gives an instruction of simultaneous change (S208), the update unit 25 of the document management server 20 simultaneously adds the management attributes that are the setting values and change the display settings and the search settings that are the related setting values (S209).

As described above, when a setting value is changed or added, for example, a related setting value is extracted as a setting value to be updated together with the setting value to be changed or added in the exemplary embodiments. A user is then asked whether to simultaneously update the setting value and the related setting value, and if the user determines that the setting value and the relate setting value are to be simultaneously updated, the setting value and the related setting value are simultaneously updated. That is, setting values that the user desires to update can be simultaneously updated. Because a related setting value is extracted in accordance with a setting value, these setting values can be simultaneously updated in accordance with a use state of the user.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a reception unit that receives update of a setting value set for an electronic document;
an extraction unit that extracts a related setting value, which relates to the setting value to be updated and is to be updated together with the setting value, in accordance with the setting value;
a presentation unit that presents the related setting value to a user; and
an update unit that, if the user gives an instruction to update the related setting value, simultaneously updates the setting value and the related setting value.

2. The information processing apparatus according to claim 1,
wherein the update of the setting value is a change of the setting value, and
wherein the extraction unit determines a same setting value as the setting value before the change as the related setting value.

3. The information processing apparatus according to claim 2,
wherein the setting value and the related setting value are a location at which the electronic document is saved.

4. The information processing apparatus according to claim 2,
wherein the electronic document is a plurality of electronic documents relating to each other in an operation.

5. The information processing apparatus according to claim 2,
wherein the presentation unit also presents an electronic document to which the related setting value is given.

6. The information processing apparatus according to claim 1,
wherein the update of the setting value is addition of an attribute for managing the electronic document, and
wherein the extraction unit extracts, as the related setting value, a setting for using the added attribute.

7. The information processing apparatus according to claim 6,
wherein the attribute is given to a plurality of electronic documents relating to each other in an operation and is a management attribute for managing the operation.

8. The information processing apparatus according to claim 7,
wherein the setting is a display setting indicating whether to display the management attribute.

9. The information processing apparatus according to claim 7,
wherein the setting is a search setting for searching for the management attribute.

10. The information processing apparatus according to claim 8,
wherein the setting is changed in accordance with the user's authority.

11. The information processing apparatus according to claim 9,
wherein the setting is changed in accordance with the user's authority.

12. The information processing apparatus according to claim 6,
wherein the presentation unit presents the related setting value in accordance with the user's authority.

13. An information processing system comprising:
an information processing apparatus that manages an electronic document; and
a viewing unit that is used to view the electronic document,
wherein the information processing apparatus includes
a reception unit that receives update of a setting value set for the electronic document,
an extraction unit that extracts a related setting value, which relates to the setting value to be updated and is to be updated together with the setting value, in accordance with the setting value,
a presentation unit that presents the related setting value to a user, and
an update unit that, if the user gives an instruction to update the related setting value, simultaneously updates the setting value and the related setting value.

14. An information processing apparatus comprising:
reception means for receiving update of a setting value set for an electronic document;
extraction means for extracting a related setting value, which relates to the setting value to be updated and is to be updated together with the setting value, in accordance with the setting value;
presentation means for presenting the related setting value to a user; and
update means for, if the user gives an instruction to update the related setting value, simultaneously updating the setting value and the related setting value.
